(19) United States
(12) Patent Application Publication
(10) Pub. No.: US 2012/0166968 A1
(43) Pub. Date: Jun. 28, 2012

(54) Method of transmitting and displaying messages and portable electronic devices thereof

(75) Inventors: Hong-Lin Lee, Taipei (TW); Wen-Hsiung Tsai, Taipei (TW); Ya-Ting Hsu, Taipei (TW)

(73) Assignee: LINKTEL INC., Taipei (TW)

(21) Appl. No.: 13/064,169

(22) Filed: Mar. 9, 2011

(30) Foreign Application Priority Data
Dec. 23, 2010 (TW) 099145579

(51) Int. Cl. G06F 3/00; G06F 3/041

(52) U.S. Cl. 715/752; 345/173

(57) ABSTRACT

A method of transmitting and displaying messages applied to portable electronic devices includes the following steps: providing a handwriting interface for a sender to compose a plurality of sent-messages on a touch screen; receiving a plurality of received-messages from a receiver; providing a dialog window wherein the dialog window is adapted for placing the sent-messages and the received-messages. Moreover, each sent-message and received-message is displayed in accordance with the time of creation of each message.

### BACKGROUND OF THE INVENTION

1. Field of the Invention

The present invention relates to a method of transmitting and displaying messages and a portable electronic device thereof.

2. Description of the Related Art

Typing is the most widespread method of inputting messages in the most commonly used Instant Messaging software. Messages sent and received are displayed from the top of a dialog window to the bottom in reverse chronological order, and not categorized by the composer of each message. Consequently, if users want to find one of the messages, they have to search through the entire body of messages to find the one they want. It is not only a waste of time but also causes eyestrain in the long run.

Touch-screen electronic devices have become more and more commonplace, increasing the feasibility of using handwritten messages. For example, an e-bulletin board capable of transmitting messages is disclosed in US 2009/0271712. The e-bulletin board digitally and graphically represents the use of Post-it notes to leave messages in daily life. The message-transmitting function enables users to send a message in the form of a virtual Post-it note to a receiver through a communication device. In addition, all composed messages will be displayed on an interface similar to a real bulletin board in the form of a memo. However, although the disclosed e-Broad's function focuses on calendar and notes-taking features, the functions of real-time transmission and message consolidation are not provided.

A method of transmitting handwritten messages used on an electronic device disclosed in U.S. Pat. No. 7,224,991 focuses on the transmitting function of handwritten messages. Functions to display sent messages or systematically manage messages that have been sent or received are not disclosed. From a user's point of view, this method is still inconvenient for reviewing previous communications.

Therefore, a new message transmitting and displaying method can be created if a graphical memo can be applied on a user interface of instant messaging software and to place dialogue into different areas according to the composer of each message. This method provides an easy way to review historical dialogue while adding an entertainment factor of putting actual objects into a graphical format.

### SUMMARY OF THE INVENTION

An object of the present invention is to provide a method of transmitting and displaying messages applied to portable electronic devices for a sender to send a sent-message to a receiver via the Internet.

Another object of the present invention is to provide a method for transmitting and displaying messages, wherein the position of the plurality of sent-message Icons and the plurality of received-message Icons in a dialog window is arranged in accordance with the time of creation of each message Icon.

To achieve the aforementioned objects, the present invention provides a method of transmitting and displaying messages applied to a portable electronic device for a sender to send messages to a receiver via the Internet, and then the receiver can send a message back to the sender via the Internet. The portable electronic device contains a touch screen, and the method of transmitting and displaying messages includes the following steps:

a. providing a handwriting interface on a touch screen for a sender to compose a plurality of sent-message Icons;

b. receiving a plurality of received-message Icons from the receiver; and

c. providing a dialogue window for placing the plurality of sent-message Icons and the plurality of received message Icons, wherein the position of the plurality of sent-message Icons and the plurality of received-message Icons in the dialog window are arranged in accordance with the time of creation of each message Icon.

According to the embodiments of the present invention, at least two different arrangements are available for displaying the sent-message Icons and the received-message Icons in the dialog window.

### BRIEF DESCRIPTION OF THE DRAWINGS

FIG. 1 is a schematic drawing of the environment according to the present invention.

FIG. 2 illustrates the functionalities of the message-transmitting program's main program codes.

FIG. 3 is a flow chart of an embodiment of the present invention.

FIG. 4 is a flow chart of the message-categorizing procedure of the present invention.

FIG. 5 is a schematic drawing of the first embodiment of the present invention.

FIG. 6 is a schematic drawing of the first embodiment of composing messages of the present invention.

FIG. 7 is the first schematic drawing of the dialog window of the first embodiment of the present invention.

FIG. 7A is the second schematic drawing of the dialog window of the first embodiment of the present invention.

FIG. 8 is the third schematic drawing of the dialog window of the first embodiment of the present invention.

FIG. 8A is an enlarged message Icon of the first embodiment of the present invention.

FIG. 9 is a schematic drawing of the handwriting interface of the first embodiment of the present invention.

FIG. 10 is the third schematic drawing of the dialog window of the first embodiment of the present invention.

FIG. 11 is a schematic drawing of the first embodiment of displaying message Icons of the present invention.

FIG. 12 is a schematic drawing of the second embodiment of displaying message Icons of the present invention.

FIG. 13 is a schematic drawing of the third embodiment of displaying message Icons of the present invention.

FIG. 14 is a schematic drawing of the fourth embodiment of displaying message Icons of the present invention.

### DETAILED DESCRIPTION OF THE PREFERRED EMBODIMENT

The advantages and innovative features of the invention will become more apparent from the following detailed descriptions when taken together with the accompanying drawings.

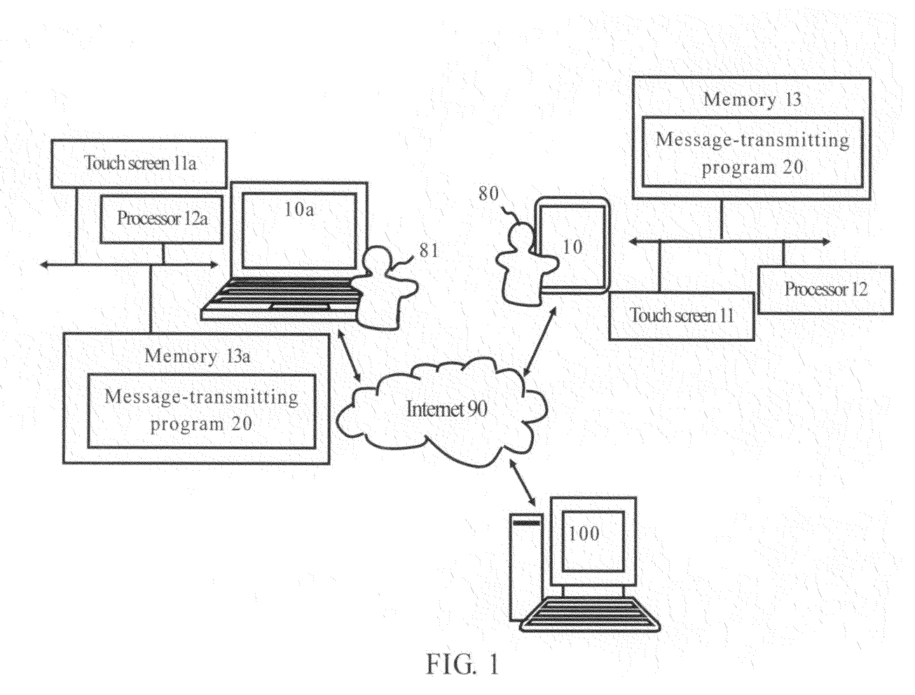

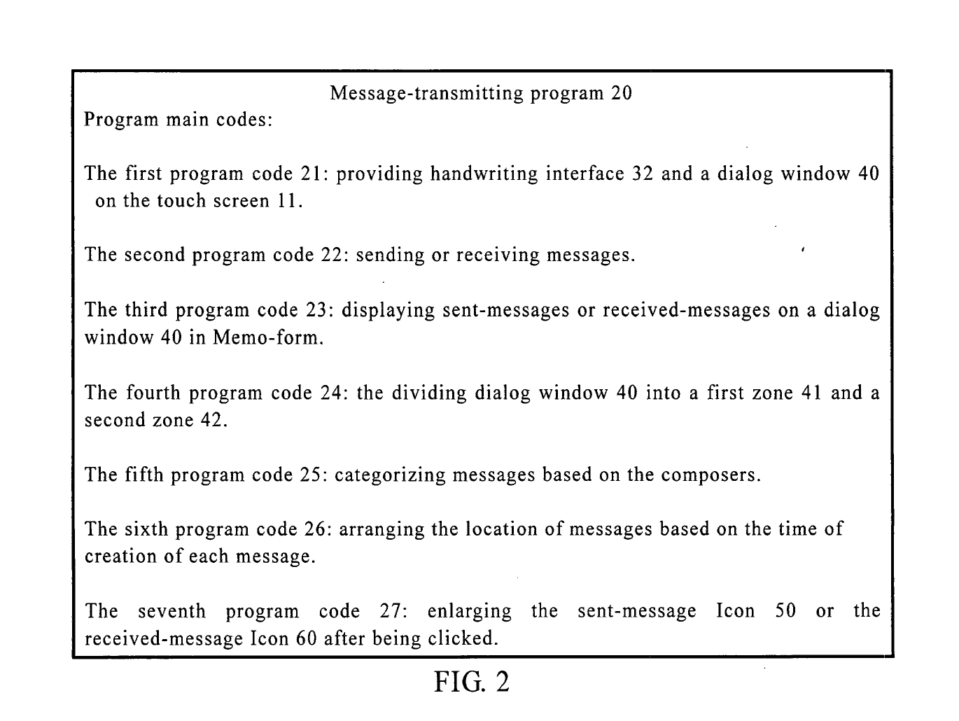

Please refer to FIG. 1 and FIG. 2, related to the schematic drawing of the environment according to the present invention and the functions of the main program codes of the message-transmitting program 20. The portable electronic device 10 of the present invention mainly comprises a touch screen 11, a processor 12, and a memory 13, wherein the message-transmitting program 20 is saved in the memory 13. The method of transmitting and displaying message of the present invention is accomplished through the processor 12 by executing the message-transmitting program 20 to implement the steps of the present invention. Please refer to FIG. 2. The main program codes related to the present invention are listed individually, and the related details will be discussed in conjunction with the steps of the present invention. In this embodiment, the sender 80's portable electronic device 10 is a tablet personal computer (Tablet PC), and the receiver 81's portable electronic device 10a is a laptop with a touch screen 11a. The message-transmitting program 20 is saved in the memory 13a and driven by the processor 12a. It is noted that the present invention can be applied to various electronic devices; i.e., the portable electronic device 10 can be a personal computer (PC), a laptop, a mobile phone, a personal digital assistant (PDA), or other devices equipped with touch screens and capable of running the message-transmitting program 20.

Messages can be transmitted between the portable electronic device 10 and the portable electronic device 10a directly via an Internet 90 (peer to peer), in which a Server 100 mainly processes location queries by both sides or transmits messages from both sides directly through the Server 100. The above-mentioned transmitting method is a well-known technology, and not the primary issue of the present invention; therefore, no further description is provided.

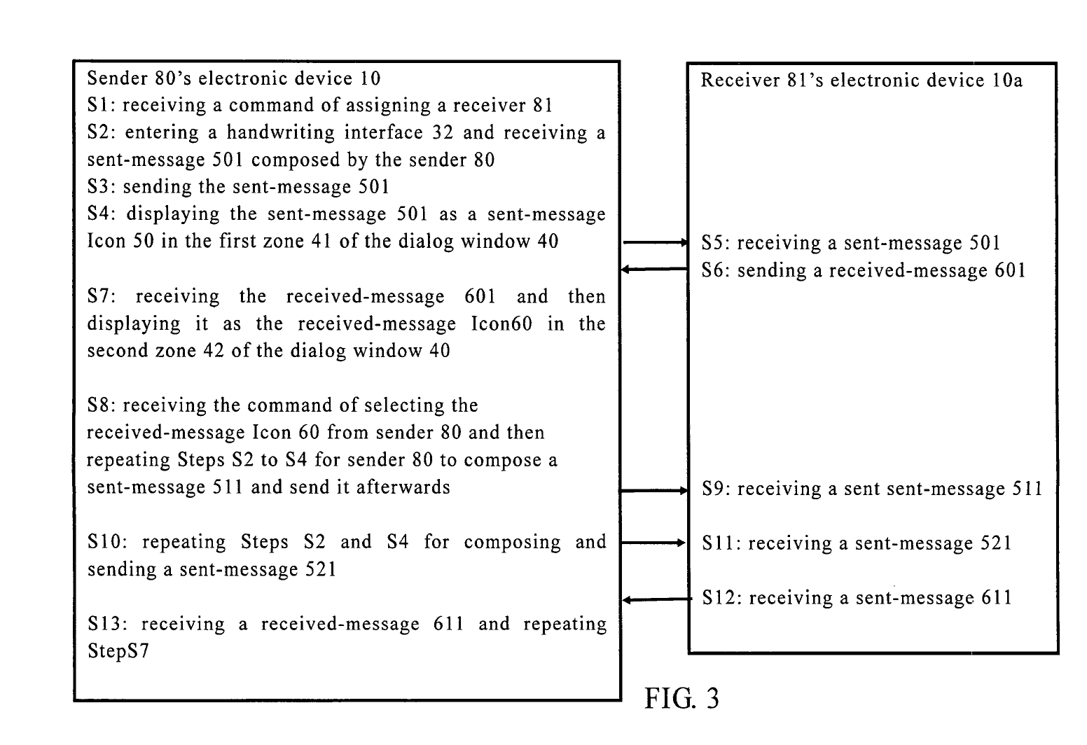

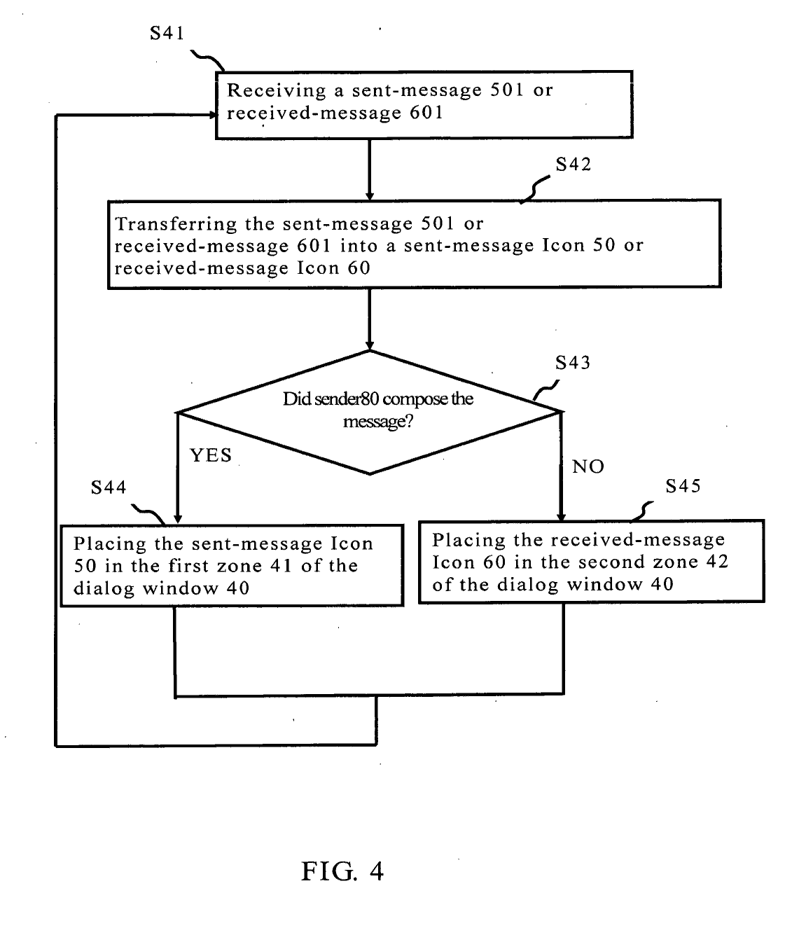

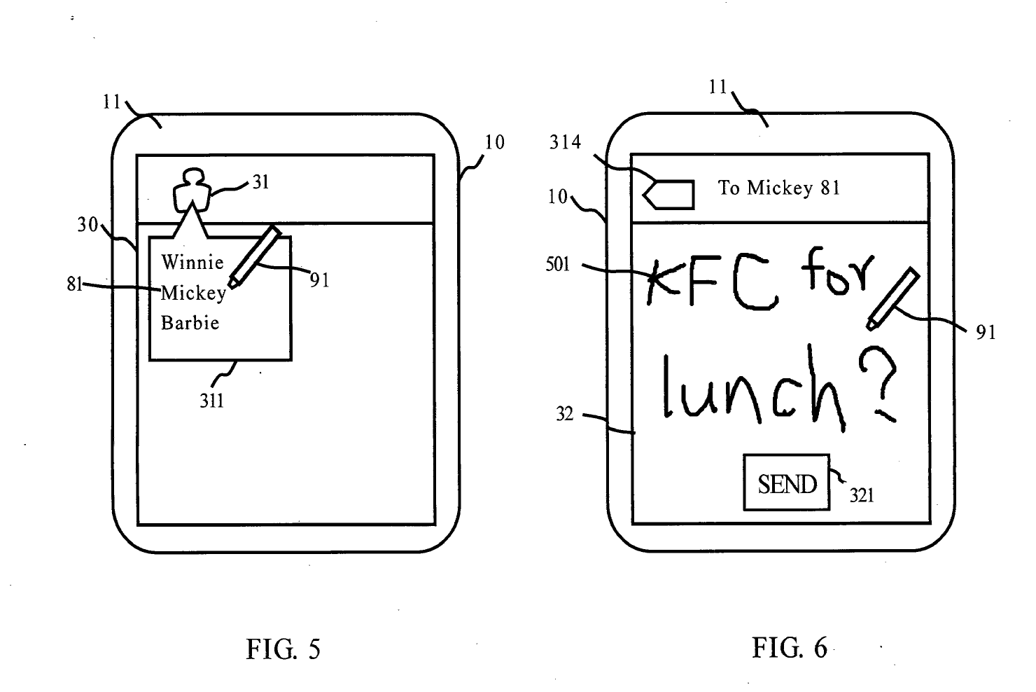

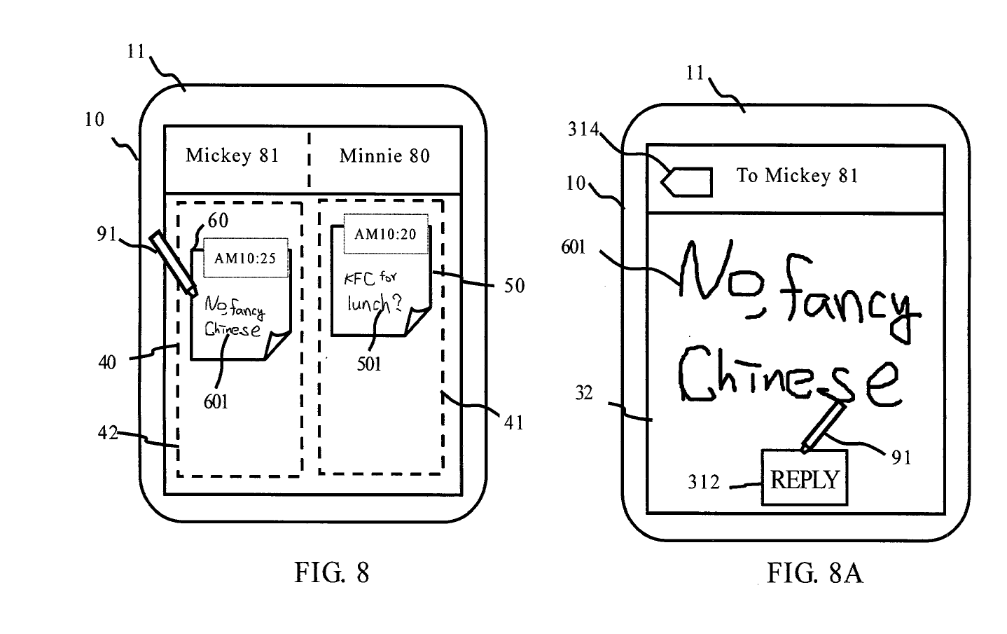

Please refer to FIG. 3 and FIG. 4, related to a flow chart of the present invention and a flow chart of the message-categorizing procedure. Please refer also to FIG. 2, FIG. 5 to FIG. 11, and FIG. 8A together in order to comprehend the steps of the method of transmitting and displaying messages of the present invention in detail.

### Step S1:

Receiving a command of assigning a receiver 81

Please refer to FIG. 5. The sender 80 clicks on a “Contact Icon 31” in a function window 30, and a “Contact List 311” will pop out, which allows sender 80 to choose one friend from the “Contact List 311” as a receiver 81 to send messages. For example, the sender 80 clicks on “Mickey” in this embodiment; consequently, Mickey is the receiver 81 (hereinafter referred to as the receiver 81).

### Step S2:

Entering into a handwriting interface 32 and then receiving a sent-message 501 composed by the sender 80

Please refer to FIG. 6; after executing the message-transmitting program 20, the first program code 21 provides a handwriting interface 32 on a touch screen 11 for the sender 80 to compose characters or graphs on the handwriting interface 32, where a sent-message 501 can be created. It is noted that the sender 80 uses a stylus 91 to complete the handwritten character input procedure in this embodiment, but the present invention is not limited to this. From practical aspects, the sender 80 can input handwritten characters simply with a finger or other auxiliary device. Furthermore, handwriting is not the only available input method of the present invention. The sender 80 can also employ a software keyboard or an external keyboard for inputting characters or graphs to increase the range of adaptability of the present invention.

### Step S3:

Sending the sent-message 501

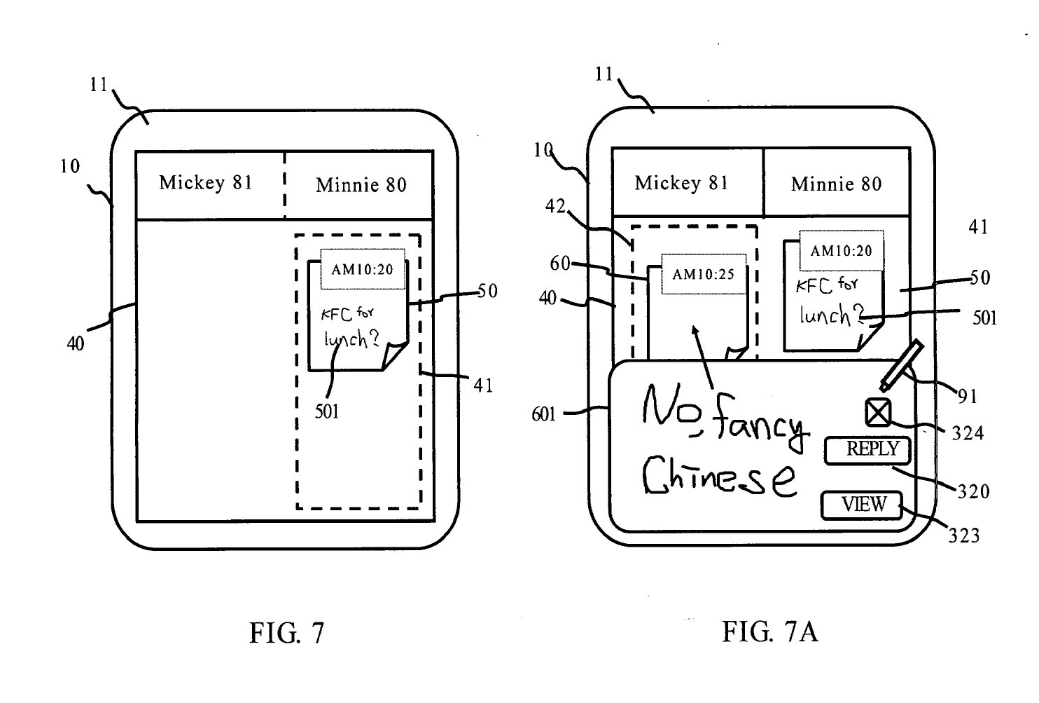

As shown in FIG. 6, if the content of sent-message 501 is finished, the sender 80 can click on the “Send Button 321” located at the bottom of the handwriting interface 32. The sent-message 501 can be transmitted from the electronic device 10 to the receiver 81's portable electronic device 10a. The function of sending and receiving messages is completed by the second program code 22 of the message-transmitting program 20. At the same time, the sender 80 can click the “Back Button 314” to enter a dialog window 40 (FIG. 7).

### Step S4:

Displaying the sent-message message 501 as a sent-message Icon 50 in the first zone 41 of the dialog window 40

Please refer to FIG. 4 and FIG. 7. Step S4 requires further execution of a message-categorizing procedure S41 to S45 (FIG. 4) in order to complete the function of this step. As shown in FIG. 4, before displaying all the sent- or received-messages on the dialog window 40 in the portable electronic device 10, a message-categorizing procedure will be implemented as follows:

Step S41: receiving all sent- or received-messages.

As shown in FIG. 4 and FIG. 7, the sent message is sent-message 501 in this embodiment.

Step S42: transferring sent-message 501 into sent-message Icon 50.

Step S43: identifying the composer of the sent-message 501

If the sender 80 is the composer, implement Step S44.

If the sender 80 is not the composer, implement Step S45.

Step S44: placing the sent-message Icon 50 in the first zone 41 of the dialog window 40

Step S45: placing the received-message Icon 60 in the second zone 42 of the dialog window 40

As shown in FIG. 7, because the sender 80 is the composer of the sent-message 501 in this embodiment, the sent-message Icon 50 will be placed in the first zone 41 of the dialog window 40 by executing Step S44. The message-categorizing procedure is accomplished by the third program code 23, the fourth program code 24, and the fifth program code 25 of the message-transmitting program 20.

Moreover, as shown in FIG. 7, the sent-message Icon 50 is presented in the form of a Memo on dialog window 40, and the content of the sent-message 501 will be displayed as well. It is noted that the Memo-form of the sent-message Icon 50 in this embodiment is the graphical feature of an ordinary memo for general purposes. Although the graphical Memo is rectangular in this embodiment, the graphical Memo can be other geometrical shapes, such as elliptical, pentagonal, or others.

### Step S5:

The receiver 81's portable electronic device 10a receiving sent-message 501 from the sender 80's portable electronic device 10

### Step S6:

The receiver 81 composing a received-message 601, and the received-message 601 will be sent to the sender 80's portable electronic device 10 through the portable electronic device 10a afterwards

### Step S7:

Receiving the received-message 601 and then displaying it as the received-message Icon 60 in the second zone 42 of the dialog window 40

As shown in FIG. 7A, the receiver 81's portable device 10a sent the received-message 601 back to the sender 80's portable electronic device 10 at AM10:25. The received-message 601, displayed at the lower part of the dialog window 40 by the sender 80's portable electronic device 10, allows the sender 80 to read the content of the received-message 601. Meanwhile, a “Reply button 320”, a “View button 323”, and a “close button 324” are situated on one side of the received-message 601. If the sender 80 clicks on the “close button 324” or areas not belonging to any message Icons, the size of the received-message 601 will be reduced and the received-message 601 will be displayed in the form of the received-message Icon 60 in the second zone 42 of the dialog window 40 (the pointed area shown in FIG. 8.)

If the sender 80 clicks on other message Icons in the dialog window 40, such as the sent-message Icon 50 or received-message Icon 60 shown in FIG. 8, the clicked message Icon will be enlarged accordingly. The enlarged message Icon is shown in FIG. 8A. Detailed and related explanation of the enlargement will be presented in the following paragraph.

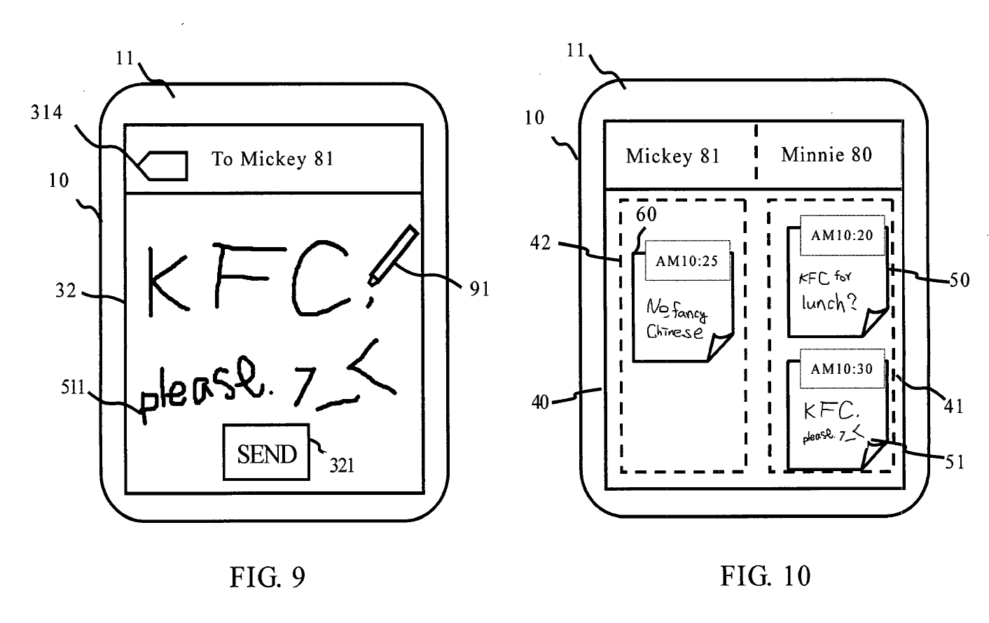

Clicking on the “Reply button 320” for entering the handwriting interface 32 directly allows the sender 80 to compose content as a reply (shown in FIG. 9). It is noted that the received-message 601 can be placed in any area in the dialog window 40, and is not restricted to the above-mentioned embodiment, and that the relative positions among the received-message 601, the “Reply button 320”, the “View button 323”, and the “close button 324” can be changed. FIG. 7A is for demonstration only.

In this embodiment, the sender 80 clicks on the “close button 324” so that the sender 80's portable electronic device 10 will convert the received-message 601 into the received-message Icon 60. In order to accomplish this task, message-transmitting program 20 will execute the message-categorizing procedure, which is basically similar to Step S4. Compared to Step S4, the only difference is the composer of the received-message 601. Since the receiver 81 is the composer of the received-message 601 (shown in FIG. 4), Step S45 is implemented right after Step S43 for placing the received-message Icon 60 in the second zone 42 of the dialog window 40.

Furthermore, the sent-message Icon 50 and the received-message Icon 60 are marked with the time when the message was created in this embodiment. In the example provided, the sent-message Icon 50 was created at AM10:20, whereas the received-message Icon 60 was created at AM10:25. It is noted that the time of creation of messages in this embodiment is the time when the sent-message 501 was sent or the time when the received-message 601 was received, but the present invention is not limited to this arrangement. In addition, the sixth program code 26 of the message-transmitting program 20 will arrange the location of the sent-message Icon 50 and the received-message Icon 60 in the dialog window 40 in accordance with the time of creation of each message. In other words, message Icons will be placed in chronological order from the top of the dialog window 40. Based on the same rule, as shown in FIG. 8, the location of the sent-message Icon 50 will be slightly higher than that of the received-message Icon 60.

### Step S8:

Receiving the command of selecting the received-message Icon 60 from the sender 80, and repeating Steps S2 to S4 for the sender 80 to compose a sent-message 511 and send it afterwards

Please refer to FIG. 8 to FIG. 10 and FIG. 8A, as shown in FIG. 8; if the sender 80 wants to read the content of each message Icon clearly, the sender 80 simply clicks on the received-message Icon 60 in the dialog window 40 and the content of the received-message Icon 60 will be enlarged accordingly (FIG. 8A). The above-mentioned function is accomplished by the seventh program code 27 of the message-transmitting program 20.

At this point, the sender 80 can click on the “Reply Button 312” in order to enter the handwriting interface 32 to compose a sent-message 511 for the receiver 81. After that, the sender 80 presses the “Send Button 321” to send the sent-message 511 to the receiver 81's portable electronic device 10a (shown in FIG. 9). As shown in FIG. 10, after the sent-message 511 is transmitted and the software returns to the dialog window 40, the sent-message 511 will be displayed as a sent-message Icon 51 beneath the sent-message Icon 50 in the first zone 41 because the sent-message Icon 51 was created later than the sent-message Icon 50.

### Step S9:

Portable electronic device 10a receiving sent-message 511

### Step S10:

Portable electronic device 10 repeating Steps S2 and S4 for the receiver 81 to compose a sent-message 521 and to send it afterwards

### Step S11:

Portable electronic device 10a receiving the sent-message 521

### Step S12:

Portable electronic device 10a sending the received-message 611

### Step S13:

Receiving received-message 611 and repeating Step S7

Please refer to Step S2 to Step S7 for details about Step S8 to Step S13, since those are repeated steps; i.e., the sender 80 and the receiver 81 send messages to each other and, therefore, the detailed description is omitted.

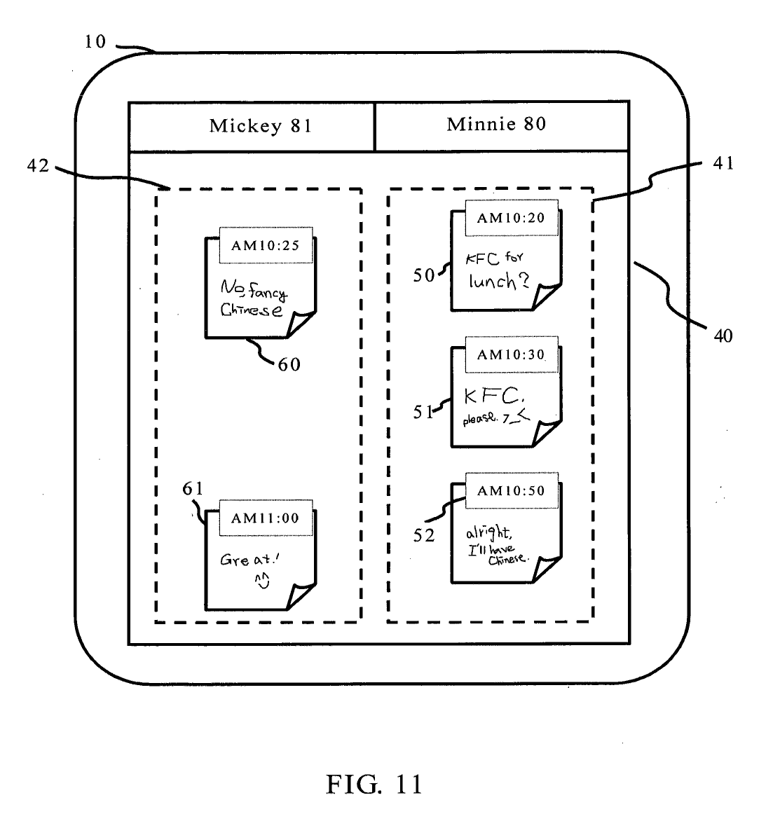

As shown in FIG. 11, after completing Step S13, the locations of each of the sent-message Icons 50, 51, 52 and received-message Icons 60, 61 in the dialog window 40 are arranged in accordance with the time of creation of each message in this embodiment. Because the received-message Icon 61 is the most recently created message, having been created after the Sent-message Icon 52, the location of the received-message Icon 61 in the second zone 42 is lower than that of the location of the sent-message Icon 52 in the first zone 41 in order to emphasize the time difference.

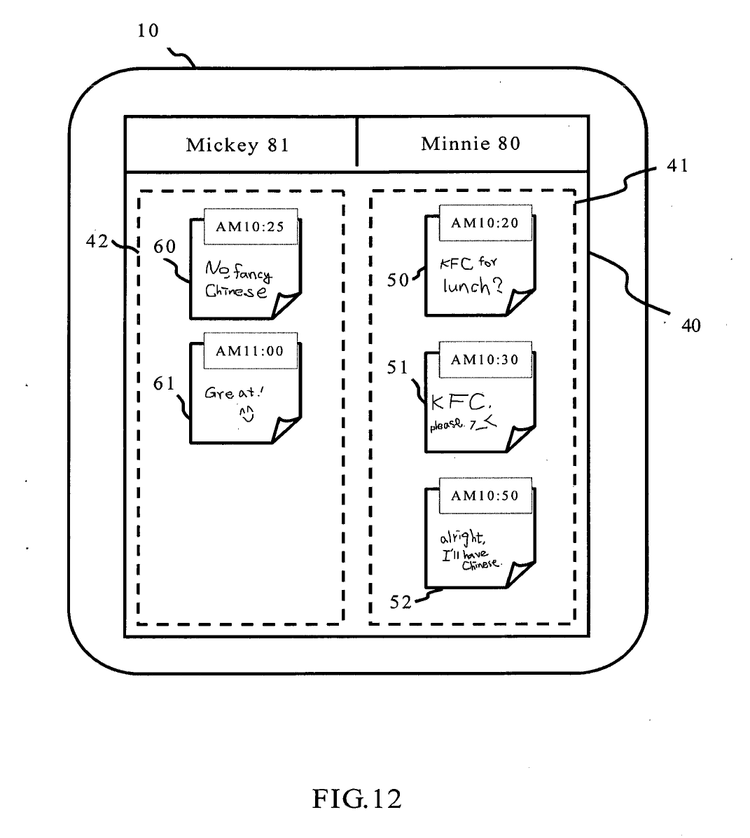

FIG. 12 is the second embodiment of displaying message Icons of the present invention. In this embodiment, the sent-message Icons 50, 51, 52 in the first zone 41 and the received-message Icons 60, 61 in the second zone 42 are displayed separately in accordance with the time of creation of each message. Therefore, the received-message Icon 61 will be located right beneath the received-message Icon 60. In other words, the time of creation of the sent-message Icon 50, 51, 52 in the first zone 41 has no effect on the location arrangement of the received-message Icons in the second zone.

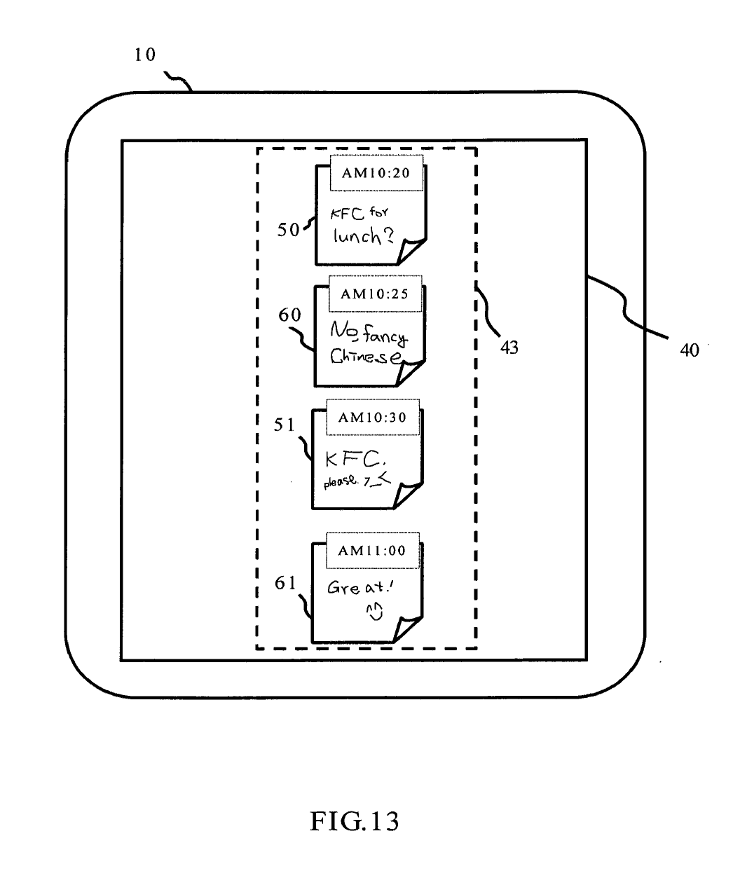

FIG. 13 is the third embodiment of displaying message Icons of the present invention. As shown in FIG. 13, the sent-message Icon 50 and the received-message Icon 60 are both displayed in an Icon display area 43 in the dialog window 40, wherein the position of each message Icon is arranged in accordance with the time of creation of each message Icon. Various colors can be used to distinguish the sent-message Icon 50 and the received-message Icon 60. However, this kind of distinguishing method cannot be represented in FIG. 13 in this specification because drawings have to meet the official criteria of the format of drawings in patent specifications. It is noted that the areas for displaying sent-message Icons and received-message Icons are not restricted, and the Icon display area 43 is only for demonstration; any part of the dialog window 40 can be the Icon display area 43. Moreover, sent-message Icons and received-message Icons can be differentiated by using different geometrical shapes for Icons.

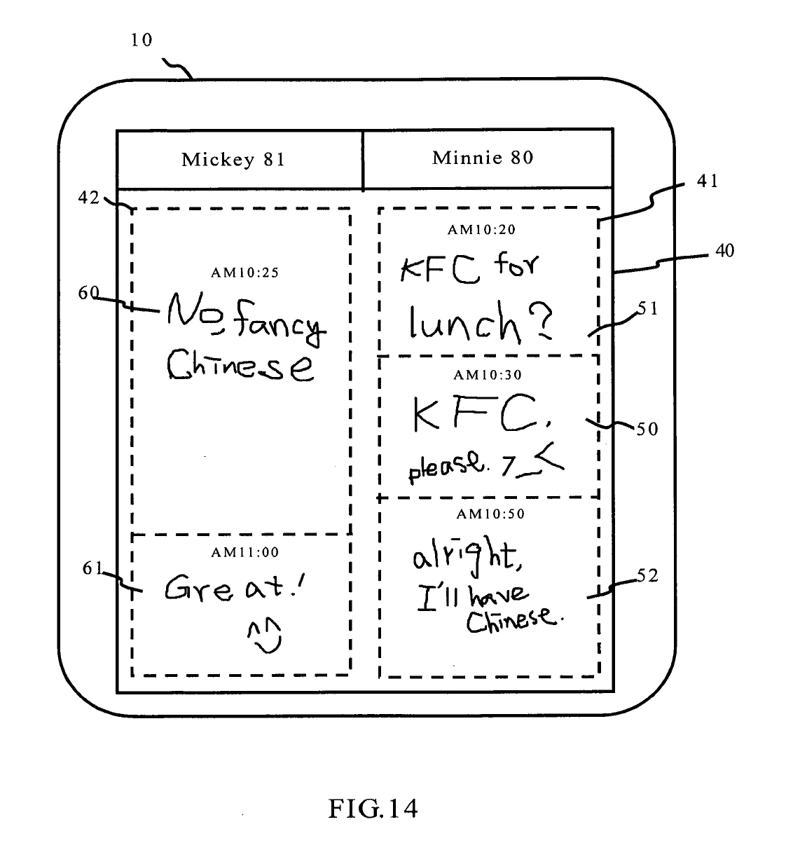

It is noted that the sent-message Icon 50 and the received-message Icon are displayed separately in Memo form in the above-mentioned embodiments, but the present invention is not limited to this format. FIG. 14 is the fourth embodiment of displaying message Icons of the present invention. As shown in FIG. 14, each message Icon can be linked together; i.e., it is possible that no gaps between message Icons. Each message Icon can be separated by dotted lines, solid lines, etc., and the size of each message Icon can be different. Each message Icon can also be enlarged after being clicked.

It is noted that the steps of the method of transmitting and displaying messages of the present invention are not restricted to the above-mentioned order. As long as the objects of the present invention can be achieved, the order of the above-mentioned steps can be changed and modified. In addition, the available message content is not limited to characters or graphs; any other format that can be input by the sender 80 or the receiver 81, such as oral messages, coordinates, media files, etc., is acceptable.

It is noted that the above-mentioned embodiments are only for demonstration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A method of transmitting and displaying messages applied to a portable electronic device for a sender to send a sent-message to a receiver via an Internet, and then the receiver can send a received-message back to the sender via the Internet, wherein the portable electronic device comprises a touch screen, the method of message transmitting and displaying comprising the following steps:
a. providing a handwriting interface on the touch screen for the sender to compose a plurality of sent-message Icons;
b. receiving a plurality of received-message Icons from the receiver; and
c. providing a dialogue window for placing the plurality of sent-message Icons and the plurality of received-message Icons, wherein the position of the plurality of sent-message Icons and the plurality of received-message Icons in the dialog window is arranged in accordance with the time of creation of each message Icon.

2. The method of transmitting and displaying messages as claimed in claim 1, the dialog window further comprising a first zone and a second zone, wherein the first zone is adapted to place the plurality of sent-message Icons and the second zone is adapted to place the plurality of received-message Icons.

3. The method of transmitting and displaying messages as claimed in claim 2, wherein the plurality of sent-message Icons and the plurality of received-message Icons are both displayed along a same direction in the dialog window.

4. The method of transmitting and displaying messages as claimed in claim 3, wherein the direction of displaying the plurality of sent-message Icons and the plurality of received-message Icons is from the top to the bottom.

5. The method of transmitting and displaying messages as claimed in claim 4, wherein the plurality of sent-message Icons and the plurality of received-message Icons are displayed in the dialog window in the form of a Memo.

6. The method of transmitting and displaying messages as claimed in claim 5, wherein the plurality of sent-message Icons and the plurality of received-message Icons can be enlarged after being clicked.

7. The method of transmitting and displaying messages as claimed in claim 6, wherein the method of transmitting and displaying messages further provides a Reply Button for the sender to click after the received-message Icon is enlarged by clicking.

8. The method of transmitting and displaying messages as claimed in claim 1, wherein the plurality of sent-message Icons and the plurality of received-message Icons are displayed in the dialog window in the form of a Memo.

9. The method of transmitting and displaying messages as claimed in claim 8, wherein the plurality of sent-message Icons and the plurality of received-message Icons can be enlarged after being clicked.

10. The method of transmitting and displaying messages as claimed in claim 9, wherein the method of transmitting and displaying messages further provides a Reply Button for the sender to click after the received-message Icon is enlarged by clicking.

11. A portable electronic device allowing a sender to send a sent-message to a receiver via an Internet, and then the receiver can send a received message back to the sender via the Internet, the portable electronic device comprising:
a touch screen;
a processor;
a memory electrically connected to the processor, the memory comprising a message-transmitting program, wherein the following functions can be accomplished while the processor executes the message-transmitting program:
a. providing a handwriting interface on the touch screen for the sender to compose a plurality of sent-message Icons;
b. receiving a plurality of received-message Icons from the receiver; and
c. providing a dialogue window for placing the plurality of sent-message Icons and the plurality of received message Icons, wherein the positions of the plurality of sent-message Icons and the plurality of received-message Icons in the dialog window are arranged in accordance with the time of creation of each message Icon.

12. The portable electronic device as claimed in claim 11, the dialog window further comprising a first zone and a second zone, wherein the first zone is adapted to place the plurality of sent-message Icons, and the second zone is adapted to place the plurality of received-message Icons.

13. The portable electronic device as claimed in claim 12, wherein the plurality of sent-message Icons and the plurality of received-message Icons are both displayed along the same direction in the dialog window.

14. The portable electronic device as claimed in claim 13, wherein the direction of displaying the plurality of sent-message Icons and the plurality of received-message Icons is from the top to the bottom.

15. The portable electronic device as claimed in claim 14, wherein the plurality of sent-message Icons and the plurality of received-message Icons are displayed in the dialog window in a Memo-form.

16. The portable electronic device as claimed in claim 15, wherein the plurality of sent-message Icons and the plurality of received-message Icons can be enlarged after being clicked.

17. The portable electronic device as claimed in claim 16, wherein the portable electronic device further provides a Reply Button for the sender to click after the received-message Icon is enlarged by clicking.

18. The portable electronic device as claimed in claim 11, wherein the plurality of sent-message Icons and the plurality of received-message Icons are displayed in the dialog window in a Memo-form.

19. The portable electronic device as claimed in claim 18, wherein the plurality of sent-message Icons and the plurality of received-message Icons can be enlarged after being clicked.

20. The portable electronic device as claimed in claim 19, wherein the portable electronic device further provides a Reply Button for the sender to click after the received-message Icon is enlarged by clicking.
